(19) United States
(12) Patent Application Publication
(10) Pub. No.: US 2025/0264997 A1
(43) Pub. Date: Aug. 21, 2025

(54) STORAGE DEVICE AND OPERATING METHOD THEREOF

(71) Applicant: SK hynix Inc., Gyeonggi-do (KR)

(72) Inventor: Kyu Ho CHOI, Gyeonggi-do (KR)

(21) Appl. No.: 19/055,444

(22) Filed: Feb. 17, 2025

(30) Foreign Application Priority Data
Feb. 19, 2024 (KR) 10-2024-0023461

(51) Int. Cl. G06F 3/06

(52) U.S. Cl. CPC G06F 3/0613; G06F 3/0634; G06F 3/0659; G06F 3/0679

(57) ABSTRACT

A storage device includes a memory device and a controller connected to an external device and configured to control the memory device. When a write booster operation mode is activated by the external device, the controller is further configured to receive, from the external device, a first data write command for the first storage area, store, in the write booster area, first write data corresponding to the first data write command, map address information of the write booster area where the first write data has been stored to address information of the first storage area corresponding to the first data write command, and increase a write address pointer of the first storage area based on an amount of the first write data.

### CROSS-REFERENCE TO RELATED APPLICATIONS

The present application claims the benefit 35 U.S.C. 119 (a) of Korean Patent Application No. 10-2024-0023461, filed on Feb. 19, 2024, the entire contents of which is incorporated herein for all purposes by this reference.

### FIELD

Embodiments of the present disclosure relate to a storage device and more particularly to a write booster operating method in a device implemented as a zone storage.

### BACKGROUND

A storage device is capable of storing data based on requests of a computer, a mobile terminal such as a smartphone, and a tablet PC, and a host such as various electronic devices.

The storage device may further include a controller for controlling a memory (e.g., volatile memory/non-volatile memory). Such a controller receives commands from the host and performs or controls operations to read, write, or erase data in the memory included in the storage device based on the received commands.

A storage device based on the universal flash storage (UFS) standard includes a write booster technology to improve write speed of the host. The write booster technology can improve write performance by using a user data area of the storage device as a temporary single level cell (SLC) buffer without reducing capacity.

Recently, a storage device (e.g., zoned universal flash storage (ZUFS) and zoned name space solid storage drive (ZNS SSD)) uses zone storage technology. The storage device can improve performance by dividing memory that can store data into a plurality of zones, distinguishing data based on purpose or frequency of use, and storing data in different zones.

The zone storage technology generally has a standard for writing data to consecutive addresses in each zone and for not allowing data to be truncated and written at the boundary of the zone.

When the zone storage technology and the write booster technology are used together, a conflict may occur between the two technologies, making it impossible to achieve the original purpose of improving the performance by writing data to consecutive addresses in the zone.

### SUMMARY

Embodiments of the present disclosure provide an operating method of a storage device for avoiding or mitigating a conflict caused by activating the zone memory technology and the write booster technology.

One embodiment of the present disclosure is a storage device including a memory device and a controller connected to an external device and configured to control the memory device.

The controller configures the memory device to include a first storage area, a second storage area and a write booster area, the second storage area having a storage type different from that of the first storage area.

When a write booster operation mode is activated by the external device, the controller is further configured to receive, from the external device, a first data write command for the first storage area, store, in the write booster area, first write data corresponding to the first data write command, map address information of the write booster area where the first write data has been stored to address information of the first storage area corresponding to the first data write command, and increase a write address pointer of the first storage area based on an amount of the first write data.

Another embodiment of the present disclosure is an operating method of a controller. The operating method includes configuring a memory device to include a first storage area, a second storage area and a write booster area, the second storage area having a storage type different from that of the first storage area, activating a write booster operation mode, receiving, from an external device, a first data write command for the first storage area, storing, in the write booster area, first write data corresponding to the first data write command, mapping address information of the write booster area where the first write data has been stored to address information of the first storage area corresponding to the first data write command and increasing a write address pointer of the first storage area based on an amount of the first write data.

According to the embodiments of the present disclosure, the conflict caused by activating the write booster technology and the ZUFS technology at the same time is overcome, so that the performance of the storage device can be improved.

### BRIEF DESCRIPTION OF THE DRAWINGS

FIG. 1 is a view showing schematically a configuration of a storage device according to embodiments of the present disclosure;

FIG. 2 is a view showing schematically a configuration of a memory in the storage device to which zone storage technology is applied according to an embodiment of the present disclosure;

FIG. 3 is a view showing operations of the storage device according to commands from an external device according to an embodiment of the present disclosure;

FIG. 4 is a view showing schematically the configuration of the memory in the storage device to which the zone storage technology and write booster technology are applied according to an embodiment of the present disclosure;

FIG. 5 is a view showing operations of the storage device according to commands from an external device according to an embodiment of the present disclosure;

FIG. 6 is a view showing a write operation of the storage device capable of satisfying write constraint of a zone area even when a write booster is activated according to an embodiment of the present disclosure; and

FIGS. 7 to 10 are views for visually describing the operation of FIG. 6 and are views showing a state change of each area of the memory according to the operation of FIG. 6 in accordance with an embodiment of the present disclosure.

### DETAILED DESCRIPTION

Hereinafter, embodiments of the present disclosure will be described in detail with reference to the accompanying drawings.

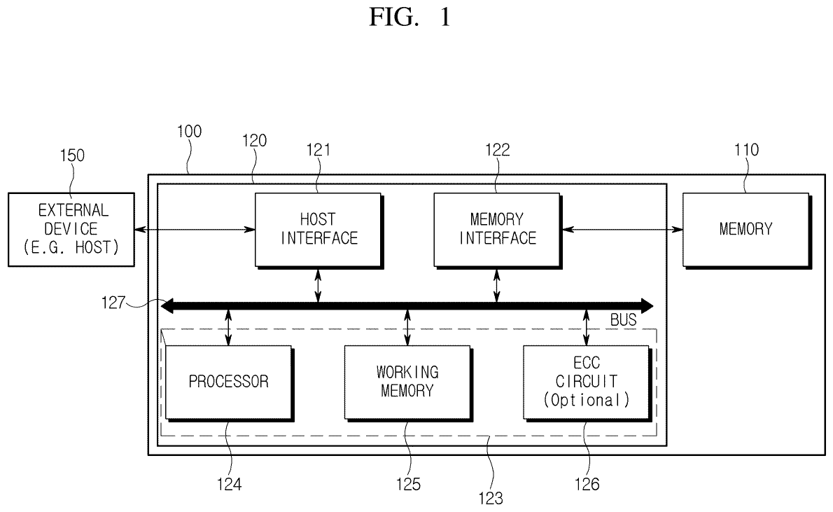

FIG. 1 shows schematically a configuration of a storage device 100 according to embodiments of the present disclosure.

Referring to FIG. 1, the storage device 100 may include a memory 110 that stores data, and a controller 120 that controls the memory 110.

The memory 110 operates in response to the control of the controller 120. In some embodiments, the operation of the memory 110 may include, for example, a read operation, a program operation (also, referred to as a write operation), and an erase operation.

For example, the memory 110 may be implemented in various types such as double data rate synchronous dynamic random access memory (DDR SDRAM), low power double data rate 4 (LPDDR4) SDRAM, graphics double data rate (GDDR) SDRAM, low power DDR (LPDDR), Rambus dynamic random access memory (RDRAM), NAND flash memory, 3D NAND flash memory, NOR flash memory, resistive random access memory (RRAM), phase change random access memory (PRAM), magnetoresistive random access memory (MRAM), ferroelectric random access memory (FRAM), or spin transfer torque random access memory (STT-RAM).

The memory 110 may be implemented to have a three-dimensional array structure. The embodiments of the present disclosure can be applied not only to a flash memory in which a charge storage layer is composed of a conductive floating gate, but also to a charge trap type flash (CTF) in which the charge storage layer is composed of an insulation layer.

The memory 110 may receive commands and addresses from the controller 120 and may access an area in a memory cell array selected by an address. That is, the memory 110 may perform an operation indicated by a command with respect to the area selected by the address.

For example, the memory 110 may perform a program operation, a read operation, and an erase operation. During the program operation, the memory 110 may program data in the area selected by the address. During the read operation, the memory 110 may read data from the area selected by the address. During the erase operation, the memory 110 may erase data stored in the area selected by the address.

The controller 120 may control the write (program), read, erase, and background operations on the memory 110. In some embodiments, the background operation may include, for example, but not limited to, one or more of garbage collection (GC), wear leveling (WL), read reclaim (RR), bad block management (BBM), hyper write migration, and SLC through migration operations.

The controller 120 may control the operation of the memory 110 in accordance with a request from an external device (e.g. a host) 150 located outside the storage device 100. In some embodiments, the controller 120 may control the operation of the memory 110 independently of the request from the external device 150.

The external device 150 may include a computer, ultra-mobile PCs (UMPCs), a workstation, a personal digital assistant (PDAs), a tablet PC, a mobile phone, a smart phone, a wearable device, an e-book, a portable multimedia player (PMP), a portable game machine, a navigation system, a black box, a digital camera, a digital multimedia broadcasting (DMB) player, a smart television, a digital audio recorder, a digital audio player, a digital picture recorder, a digital picture player, a digital video recorder, a digital video player, a storage forming a data center, one of various electronic devices constituting a home network, one of various electronic devices constituting a computer network, one of various electronic devices constituting a telematics network, a radio frequency identification (RFID) device, or a mobile device (e.g., a vehicle, a robot, a drone) that travels on the ground, in the water or in the air under human control or autonomously.

The external device 150 may include at least one operating system (OS). The operating system can manage and control overall functions and operations of the external device, and can provide mutual operations between the external device and the storage device 100. The operating system may be divided into a general operating system and a mobile operating system, depending on the mobility of external devices.

The controller 120 and the external device 150 may be separated from each other. In some embodiments, the controller 120 and the external device 150 may be implemented as one integrated device. Hereinafter, for convenience, an example will be described in which the controller 120 and the external device 150 are separated from each other.

In the illustrated embodiment of FIG. 1, the controller 120 may include a memory interface 122, a control circuit 123, and a host interface 121.

The host interface 121 provides an interface for communicating with the external device 150. For example, the host interface 121 provides an interface that uses at least one of various communication standards or interfaces such as a universal serial bus (USB) protocol, a multimedia card (MMC) protocol, a peripheral component interconnection (PCI) protocol, a PCI-express (PCI-e or PCIe) protocol, an advanced technology attachment (ATA) protocol, Serial-ATA protocol, a Parallel-ATA protocol, a small computer system interface (SCSI) protocol, an enhanced small disk interface (ESDI) protocol, an integrated drive electronics (IDE) protocol, and a proprietary protocol.

When receiving a command from the external device 150, the control circuit 123 may receive the command through the host interface 121 and may perform an operation of processing the received command.

The memory interface 122 may be connected to the memory 110 to provide an interface for communicating with the memory 110. That is, the memory interface 122 may be configured to provide an interface between the memory 110 and the controller 120 in response to control of the control circuit 123.

The control circuit 123 controls the operation of the memory 110 by performing control operations of the controller 120. To this end, the control circuit 123 may include a processor 124, and a working memory 125. Optionally, the control circuit 123 may include an error detection and correction circuit (ECC) 126.

The processor 124 may control operations of the controller 120 and may perform logical operations. The processor 124 may communicate with the external device 150 through the host interface 121 and may communicate with the memory 110 through the memory interface 122.

The processor 124 may perform a function of a flash translation layer (FTL). The processor 124 may convert (or translate) a logical block address (LBA) provided from the external device 150 into a physical block address (PBA) through the flash translation layer. Through a mapping table, the flash translation layer may receive the logical block address and may convert the logical block address into the physical block address.

There are various address mapping methods of the flash translation layer depending on a mapping unit. Representative address mapping methods include a page mapping method, a block mapping method, and a hybrid mapping method.

The processor 124 may randomize data received from the external device 150. For example, the processor 124 may randomize data received from the external device 150 by using a set randomizing seed. The randomized data may be provided to the memory 110 and programmed into the memory cell array of the memory 110.

The processor 124 may de-randomize the data received from the memory 110 during the read operation. For example, the processor 124 may de-randomize the data received from the memory 110 by using a de-randomizing seed. The de-randomized data may be output to the external device 150.

According to an embodiment, the processor 124 is an application specific integrated circuit (ASIC) where the above-described functions are implemented in the form of logic. The processor 124 can control the operation of the controller 120 based on the functions implemented in hardware.

According to another embodiment, the processor 124 is a general-purpose processor or a digital signaling processor (DSP), and may control the operation of the controller 120 by loading and executing firmware. To control operations of the controller 120 and perform logical operations, the processor 124 may execute (drive) firmware loaded into the working memory 125 during booting.

For example, the firmware may include a flash translation layer (FTL), a host interface layer (HIL), and a flash interface layer (FIL). The flash translation layer (FTL) performs a translation function between a logical address that the external device 150 requests from the storage device 100 and a physical address of the memory 110. The host interface layer (HIL) interprets a command requested from the storage device 100 by the external device 150 and transmits the command to the flash translation layer (FTL). The flash interface layer (FIL) transmits, to the memory 110, the command instructed by the flash translation layer (FTL).

Such firmware may be, for example, loaded into the working memory 125 from the memory 110 or a separate non-volatile memory (e.g., ROM, NOR Flash) located outside the memory 110. When executing booting after power-on, the processor 124 may first load all or part of the firmware into the working memory 125.

The processor 124 may perform a logic operation defined in the firmware loaded into the working memory 125 to control the operation of the controller 120. The processor 124 may store, in the working memory 125, a result of performing the logic operation defined in the firmware. The processor 124 may control the controller 120 to generate a command or signal in accordance with the result of performing the logic operation defined in the firmware. When the part of the firmware in which the logic operation to be performed is defined is not loaded into the working memory 125, the processor 124 may generate an event (e.g., interrupt) for loading the corresponding part of the firmware into the working memory 125.

The processor 124 may load, from the memory 110, meta data required to drive the firmware. The meta data is for managing the memory 110 and may include management information on user data stored in the memory 110.

The firmware may be updated while the storage device 100 is being produced or while the storage device 100 is running. The controller 120 may download new firmware from the outside of the storage device 100 and may update the existing firmware to the new firmware.

The working memory 125 may store firmware, program codes, commands, or data required to drive the controller 120. The working memory 125 may include, for example, a volatile memory such as one or more of a static RAM (SRAM), a dynamic RAM (DRAM), and a synchronous DRAM (SDRAM).

The error detection and correction circuit 126 may detect an error bit of target data by using an error correction code and may correct the detected error bit. In some embodiments, the target data may be, for example, data stored in the working memory 125 or data read from the memory 110.

The error detection and correction circuit 126 may be implemented to decode data with the error correction code. The error detection and correction circuit 126 may be implemented with a plurality of various decoders. For example, a decoder that performs non-systematic code decoding or a decoder that performs systematic code decoding may be used. Also, as another way, a hard decoder or a soft decoder may be used.

A bus 127 may be configured to provide a channel between the components 121, 122, 124, 125, and 126 of the controller 120. The bus 127 may include, for example, a control bus for transmitting various control signals, and commands, and a data bus for transmitting various data.

In some embodiments, some of the aforementioned components 121, 122, 124, 125, and 126 of the controller 120 may be removed, or some of the aforementioned components 121, 122, 124, 125, and 126 of the controller 120 may be integrated into one. In addition to the above-described components of the controller 120, one or more other components may be added.

The storage device 100 may store data in the memory 110. The basic unit of data storage in the memory 110 is a cell, and a plurality of cells may be collected together to form a page that is a minimum unit of data read and write operations. A block may include a plurality of pages and may be a minimum unit of the erase operation. A plurality of blocks is collected together to form one plane, and the memory 100 may include a plurality of planes. In some embodiments, the cell may be a single-level cell (SLC) which can store only one bit of information, a multi-level cell (MLC), a triple-level cell (TLC), and a quad-level cell (QLC), all which can store a plurality of bits of information.

For efficient storage and processing of data, zoned namespace (ZNS) proposed in NVM Express or zone storage technology for UFS described in JEDEC standard document JESD220-5, published on November 2023, may be used.

The zone storage technology divides the memory 110 of the storage device 100 into zones with small and constant capacity and stores data with the same purpose and use cycle in the same zone to utilize the storage efficiently.

A typical storage device does not divide the internal storage space and randomly stores data generated by multiple pieces of software. Also, due to the characteristics of the flash memory of which the units for writing and erasing data are different and also which cannot be overwritten, in the use of the storage, valid data and unnecessary garbage areas are mixed, making it difficult to efficiently use the storage space of the storage device. Therefore, a conventional storage device requires a garbage collection (GC) operation that obtains storage space by transferring and writing valid data to another space and deleting garbage areas. In this process, additional reads and writes occur.

Through the use of the zone storage technology, data with the same purpose and use cycle is sequentially stored in designated zones respectively and erased in units of zones, so that additional reads and writes due to garbage collection do not occur. Accordingly, the lifespan of the storage device which is affected by the number of writes can be increased by up to three to four times.

The zone storage technology can also reduce the size of a logical address to physical address (L2P) table for zoned logical units. The zone storage technology makes it mandatory to store data from consecutive addresses in the zone. Therefore, there may be no requirement for a separate L2P table for the entire zone as long as only the starting physical address and logical address of each zone are matched.

By using the zone storage technology, performance and lifespan of the storage devices can be improved.

However, when write booster technology is activated, concerns may arise in storing data in the zone due to the constraint of the zone storage technology that only data from consecutive addresses must be written to one zone.

For example, according to the JEDEC standard document JESD220-5, if a write booster region is full while data is written to the zone, a significant amount of data must be flushed before the data is continued to be written to the zone, so that the waiting time until the data writing to the zone is completed may rapidly increase.

Also, according to the write booster technology, the external device 150 may be dynamically activated and deactivated. Therefore, when the write booster is activated while a data write request is made to the zone, it must be determined whether the data is written to the zone or to the writer booster region, for the write request to the zone. If the data is written to the writer booster region, the constraint that continuous data must be written to the zone cannot be achieved. If the data is written to the zone as is, a purpose of reducing the writing latency of the external device 150 by using a write booster function cannot be achieved.

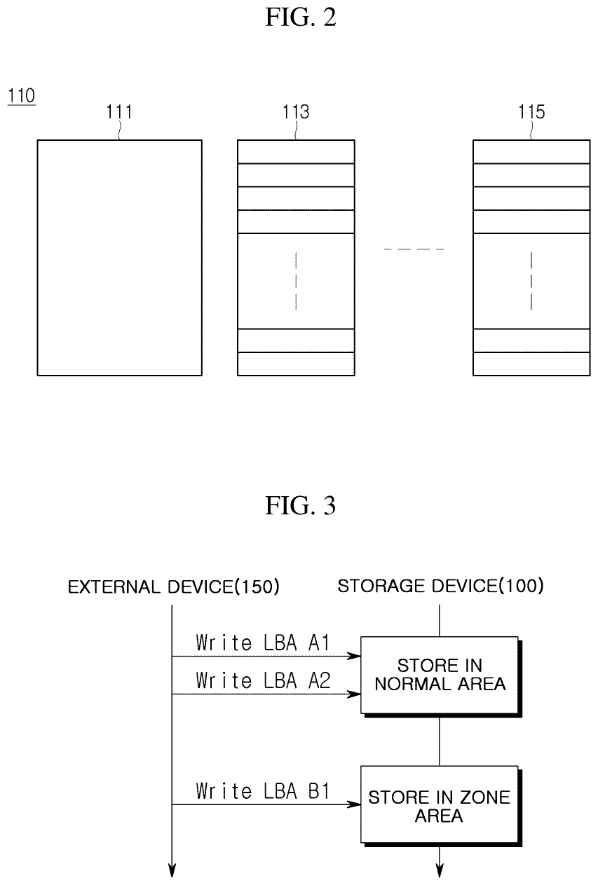

FIG. 2 is a view showing schematically a configuration of the memory 110 in the storage device 100 to which the zone storage technology is applied according to an embodiment of the present disclosure.

Referring to FIG. 2, the memory 110 of the storage device 100 may include a normal area 111 where data is written and read in a traditional manner rather than based on the zone, and zone areas 113 and 115 based on the zone.

One zone area may be composed of a plurality of unit zones. According to an embodiment, all unit zones have the same size, and the controller 120 of FIG. 1 can dynamically include the unit zone in each zone area as needed.

The zone area may be additionally divided into a plurality of zones which are distinguished according to data storage types. For example, the zone area may include a first type zone 113 and a second type zone 115. The first type zone 113 and the second type zone 115 may be referred to as a first storage area or a second storage area, respectively. According to an embodiment, the first type zone 113 may be set as a single level cell (SLC) in which each memory cell stores one bit of data, and the second type zone 115 may be set as an X-level cell (XLC) in which each cell stores two or more bits of data. In the “XLC”, X is a term indicating a specific natural number among two or more natural numbers or an abbreviation for the term. The X-level cell (XLC) may include one of a multi-level cell (MLC) that stores two bits of data in one cell, a triple-level cell (TLC) that stores three bits of data in one cell, and a quad-level cell (QLC) that stores four bits of data.

Since the unit zones included in each zone may be dynamically assigned, the number of unit zones included in each zone may be different from each other and may also be variable. Also, since the number of data that can be stored is different for each cell type, the number of cells included in the unit zone corresponding to the first type zone 113 may be different from the number of cells included in the unit zone corresponding to the second type zone 115.

In the following embodiment, each unit zone may have one of an open state, a finished state, and a closed state.

The open state is a state in which data can be written to a corresponding unit zone. The finished state is a state in which data is written to all cells of the corresponding unit zone and all memory cells of the corresponding unit zone contain data. The closed state is a state in which data has not been written to all cells of the corresponding unit zone but write protection is applied due to the constraint of data writing to a zone where only data writing to consecutive addresses is possible, so that no further writing is possible. Therefore, no further data writing is possible for zones in the closed state and finished state.

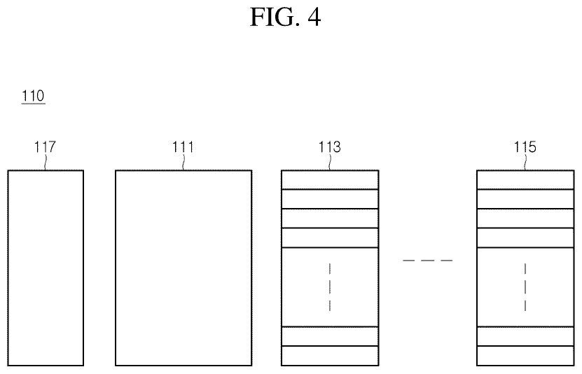

FIG. 3 is a view showing operations of the storage device 100 according to commands from an external device according to an embodiment of the present disclosure.

Referring to FIG. 3, when receiving a data write command from the external device 150, the storage device 100 or the controller 120 of the storage device 100 may determine whether to store data in the normal area 111 or in the zone areas 113 and 115 of the memory 110 based on an address at which the external device 150 intends to store the data.

According to an embodiment, the controller 120 may set a specific physical address range or logical unit of the memory 110 as the zone area, and may perform a data storage operation on the set zone area, based on the data write command which comes from the external device 150 and is for the zone area. Also, the controller 120 may set a specific physical address range or logical unit of the memory 110 as the normal area, and may perform the data storage operation on the set normal area, based on the data write command which comes from the external device 150 and is for the normal area.

Whether the data write command which comes from the external device 150 is for the zone area or the normal area is determined based on the logical address or logical block address (LBA).

In the illustrated example of FIG. 3, LBA A1 and LBA A2 are addresses which are recognized as the normal area by the external device 150. When receiving the address LBA A1 and/or LBA A2, the storage device 100 may recognize writing to the normal area. LBA B1 is an address which is recognized as the zone area by the external device 150. When receiving the address LBA B1, the storage device 100 may recognize writing to the zone area.

According to an embodiment, the external device 150 may include information on whether to write to the XLC zone or the SLC zone in the data write command. However, if the information is not included, the controller 120 of the storage device 100 may determine whether to use the SLC zone or the XLC zone as a zone in which the data is to be stored, depending on the data write command. However, whether to store the data in the SLC zone or the XLC zone may be determined by the constraint of the zone area that data from consecutive addresses must be written.

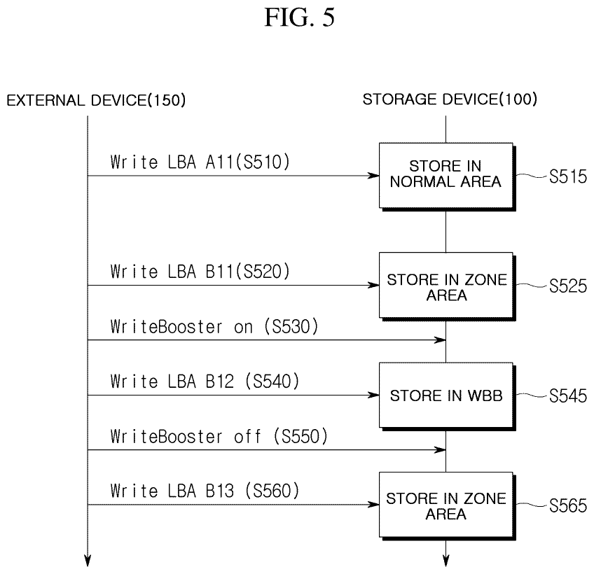

FIG. 4 is a view showing schematically the configuration of the memory 110 in the storage device 100 to which the zone storage technology and the write booster technology are applied according to an embodiment of the present disclosure.

Referring to FIG. 4, the memory 110 of the storage device 100 may include the normal area 111 where data is written and read in a traditional manner, not based on the zone, the zone-based zone areas 113 and 115, and a write booster area 117 which is used for write boosting.

The zone area and normal area are the same as those described in FIG. 2 above. When the external device 150 activates the write booster, the write booster area 117 may be additionally formed. In some embodiments, memory cells of the write booster area 117 may be set as the SLC. Accordingly, data can be written more quickly than writing to the memory cell set as the XLC. From the viewpoint of the external device 150, there is an advantage that the latency for the data write command can be reduced.

The external device 150 may activate the write booster when specific conditions are met. The external device 150 may transmit a write booster activation command to the storage device 100. The storage device 100 may set the write booster area 117 in response to the write booster activation command. Then, after the storage device 100 writes data according to subsequent data write commands from the external device 150 to the write booster area 117, the storage device 100 may flush and store the data in the normal area 111 at an idle time point when there is no data write command or data read command from the external device 150 or when the write booster area 117 is full.

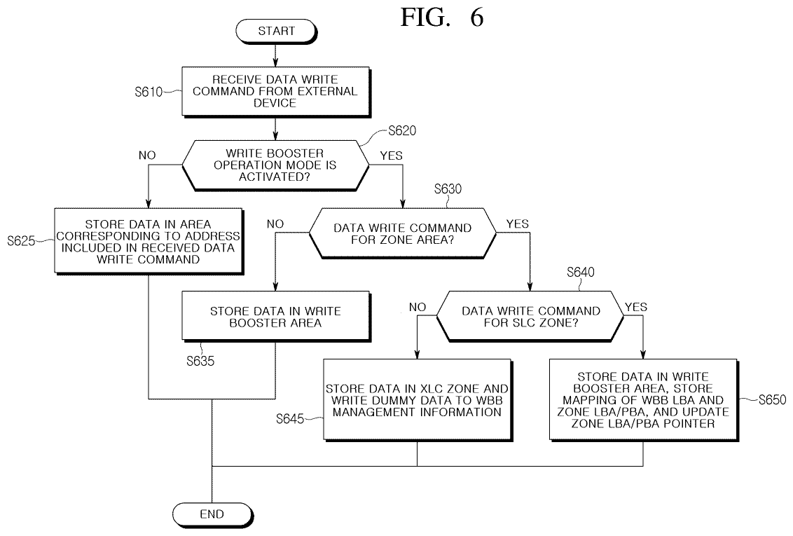

FIG. 5 is a view showing operations of the storage device 100 according to commands from the external device 150 in accordance with an embodiment of the present disclosure.

Referring to FIG. 5, when the external device 150 transmits the data write command for LBA A11 that is an address recognized as the normal area (S510), the storage device 100 may perform the data storage operation for the normal area 111 based on the data write command (S515). When the external device 150 transmits the data write command for LBA B11 that is an address recognized as the zone area (S520), the storage device 100 may perform the data storage operation for the zone areas 113 and 115 (S525).

Thereafter, the external device 150 may activate the write booster according to specific conditions (S530). For example, the specific condition may be based on the number of commands to be transmitted to the storage device 100 by the external device 150. According to an embodiment, when the number of commands to be transmitted to the storage device 100 by the external device 150 is more than a predetermined number, the external device 150 may transmit, to the storage device 100, a command for activating the write booster.

When a write booster operation mode is activated, the storage device 100 or the controller 150 of the storage device 100 may store data in the write booster area 117 in response to subsequent data write commands (S540, S545).

Then, when the external device 150 deactivates the write booster (S550) and transmits, to the storage device 100, the data write command for LBA B13 that is an address recognized as the zone area (S560), the storage device 100 may perform a write operation on the zone area based on the corresponding data write command (S565). In some embodiments, LBA B11, B12, and B13 are consecutive addresses, and the data on the consecutive addresses must be written continuously to the zone area. However, the data on LBA B12 is stored in the write booster area (WBB) rather than in the zone area, so that LBA B13 is stored after LBA B11 in the zone area. At a point of time when the write booster area is flushed later, the constraint on continuous storage is violated, so that the data may not be stored or a malfunction may occur.

The embodiments of the present disclosure propose a method for solving the constraint on the zone area writing.

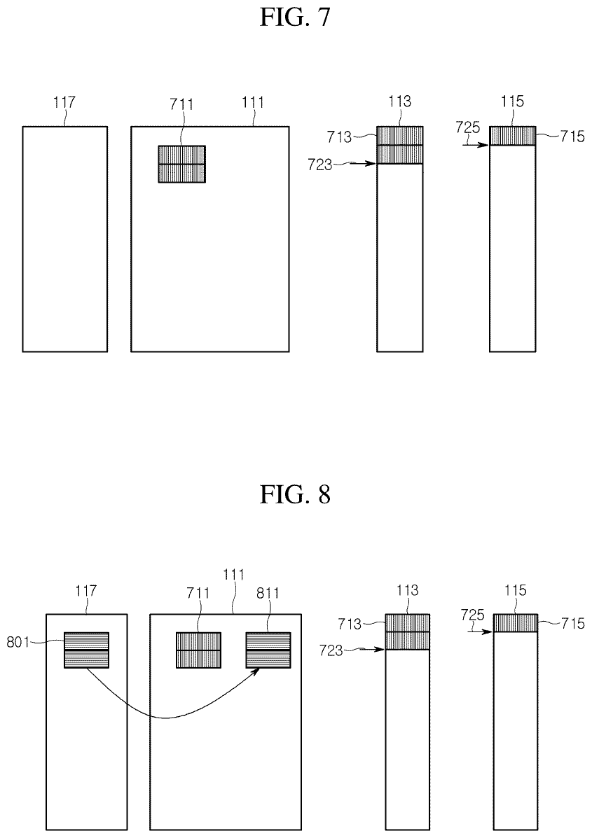

FIG. 6 is a view showing a write operation of the storage device 100 capable of satisfying write constraint of the zone area even when the write booster is activated according to an embodiment of the present disclosure.

The operations of FIG. 6 may replace operations S515, S525, S545, and S565 of FIG. 5.

Referring to FIG. 6, the storage device 100 or the controller 120 of the storage device 100 may receive the data write command from the external device 150 in S610.

In S620, the storage device 100 may determine whether the write booster is activated. According to an embodiment, the storage device 100 may receive the write booster activation command from the external device 150, and then may activate the write booster.

When the storage device 100 determines that the write booster is not activated (S620, NO), in step S625, data may be stored in an area corresponding to the address included in the received data write command.

According to an embodiment, when the address included in the data write command corresponds to the normal area 111, the storage device 100 may store data in the normal area 111 of the memory 110. That is, the storage device 100 may determine a physical address within the normal area 111 at which the data is to be stored, and may store the data at the physical address. Also, the storage device 100 may update the L2P table in which the logical address of the external device 150 and the physical address where the data of the logical address is stored are matched.

According to another embodiment, if the address included in the data write command corresponds to the zone areas 113 and 115, the storage device 100 may store data in the zone areas 113 and 115 of the memory 110.

In more detail, the storage device 100 may store data in the first type zone 113 or the first storage area if the zone in which the data is to be stored is set to the first type zone. When there is no open state unit zone of the first type zone, the storage device 100 may create a first type unit zone, place it in the open state, and store data therein. If there is already an open state unit zone, the storage device 100 may store data in the open state unit zone. However, when the amount of data that can be stored in the open state unit zone is less than that of the data to be stored, the storage device 100 may change the open state unit zone into a closed state unit zone and may create a new open state unit zone, and then may store the data to the new open state unit zone. When the zone in which the data is to be stored is set to the second type zone, the storage device 100 may find or create the second type zone 115 or find or create the open state unit zone of the second storage area, and may perform the operation of storing the data therein in the same manner.

When it is determined that the write booster is activated (S620, YES), the storage device 100 may determine, in S630, whether the data write command is a data write command for the zone area. According to an embodiment, the storage device 100 may determine whether the data write command is a data write command for the zone area based on the address included in the received data write command.

As a result of the determination in S630, when the data write command is not a data write command for the zone area (NO), the storage device 100 may, in S635, store the data in the write booster area 117 of the memory 110 and may write logical address information of the data stored as management information of the write booster area, and then may terminate. Later, when the storage device 100 is in an idle state where there is no data write command or data read command from the external device 150, the storage device 100 may transfer, to the normal area 111, the data stored in the write booster area 117. Here, the storage device 100 may determine a physical address within the normal area 111 at which the data is to be stored and may store the data at the corresponding physical address. Also, the storage device 100 may update the L2P table in which the logical address information of the data stored as management information of the write booster area and the physical address where the data of the logical address is stored are matched.

As a result of the determination in S630, when the data write command is a data write command for the zone area (YES), the storage device 100 may, in S640, determine whether the data write command is a data write command for the SLC zone. According to an embodiment, the storage device 100 may determine whether the data write command is a data write command for the SLC zone based on the address included in the received data write command.

As a result of the determination in S640, when the data write command is not a data write command for the SLC zone (NO), even though the write booster is activated, the storage device 100 may store data in the XLC zone or the second type zone of the memory 110 in S645. Also, the storage device 100 may not store actual data in the write booster area 117, and may update the management information of the write booster area with dummy data for as much as the data is stored in the write booster area 117.

As a result of the determination in S640, when the data write command is a data write command for the SLC zone (YES), the storage device 100 may store data in the write booster area 117 in S650. Also, the storage device 100 may increase a write pointer containing address information where the next data in the SLC zone is to be stored, by the amount of data stored in the write booster area 117. Also, the storage device 100 may be provided with an additional mapping table for this case. The added mapping table may be a mapping table between the logical address of the write booster area and the logical address/physical address information of the SLC zone.

Later, when the open state SLC zone changes to a closed state SLC zone or a finished state SLC zone or when the write booster area needs to be flushed, the storage device 100 may move the data stored in the write booster area 117 to the SLC zone based on the added mapping table. According to an embodiment, when a first logical address of the write booster area and a second logical address (or second physical address) of the SLC zone are mapped in the mapping table, the storage device 100 may obtain data by reading the physical address of the memory 110, which corresponds to the first logical address of the write booster area. Further, the storage device 100 may store the obtained data at the physical address (second physical address) of the memory 110, which corresponds to the second logical address of the SLC zone.

In the above description, the storage device 100 performs determination in both operations S630 and S640 based on the addresses included in the received data write command. The operations S630 and S640 may be performed in reversed order or simultaneously.

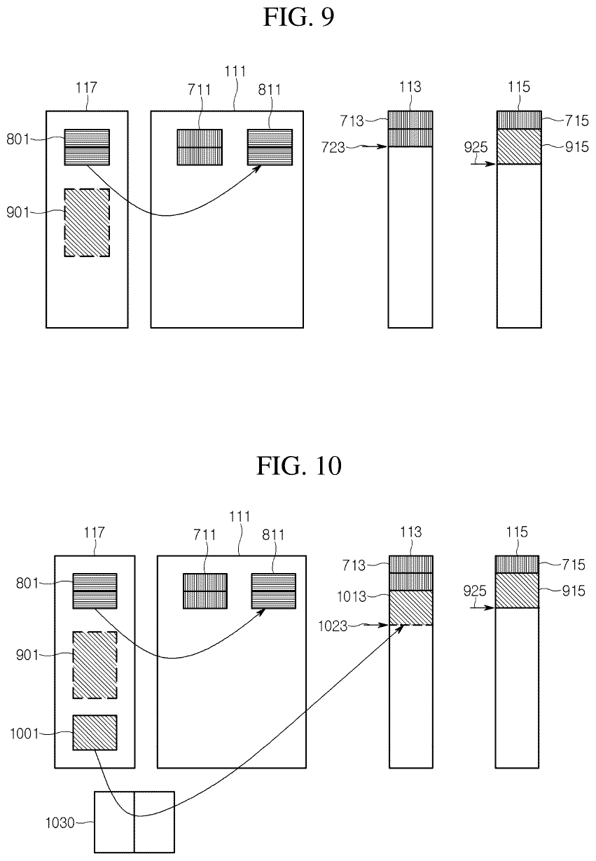

FIGS. 7 to 10 are views for visually describing the operation of FIG. 6 and are views showing a state change of each area of the memory according to the operation of FIG. 6 in accordance with an embodiment of the present disclosure.

In the embodiments of FIGS. 7 to 10, only one unit zone in the SLC zone 113 and the XLC zone 115 is displayed as the zone area.

Referring to FIGS. 6 and 7, in S625, the storage device 100 may store data in an area corresponding to the address included in the received data write command. When the address included in the received data write command is a logical address belonging to the normal area 111, the storage device 100 may determine a physical address 711 within the normal area 111 and may store the data in the memory cell corresponding to the corresponding physical address.

When the address included in the received data write command is a logical address belonging to the zone areas 113 and 115, the storage device 100 may store data 713 and 715 at an address that the write pointer of each of the zone areas 113 and 115 indicates. In addition, a value of the write pointer of each of the zone areas 113 and 115 is displayed to indicate an address at which the next data is to be stored. Therefore, when the storage device 100 receives the next data write command, the storage device 100 may determine an address at which the data is stored, based on the value of the corresponding write pointer.

Referring to FIGS. 6 and 8, when the write booster is activated and the data write command for the normal area 111 is received, the storage device 100 may store data 801 in the write booster area 117 in S635. Later, when the storage device 100 is in an idle state, the storage device 100 may transfer the data 801 stored in the write booster area 117 and may store the data 811 in the normal area 111.

Referring to FIGS. 6 and 9, when the writer booster is activated and the data write command for the XLC zone is received, the storage device 100 may immediately store data 915 in the XLC zone in S645.

The storage device 100 performs determination in both operations S630 and S640 based on the addresses included in the received data write command. The operations S630 and S640 may be performed in reversed order or simultaneously. Also, the storage device 100 may update the value 925 of the write pointer for the XLC zone. Also, the storage device 100 may update the management information of the write booster area as if dummy data 901 is stored in the writer booster buffer 117 without storing actual data.

Referring to FIGS. 6 and 10, when the writer booster is activated and the data write command for the SLC zone is received, the storage device 100 may store data 1001 in the writer booster area 117 in S650. Also, the storage device 100 may increase the value 1023 of the write pointer of the SLC zone 113 by the amount of the data stored in the write booster area 117, in such a manner as to obtain an area where the data stored in the write boost buffer 117 can be stored at the corresponding address of the SLC zone 113 in the future. Here, through a mapping table 1030, the storage device 100 may associate the address where the data of the write booster area 117 is stored with the address where the data of the SLC zone is to be stored.

Later, when the open state SLC zone changes to a closed state SLC zone or a finished state SLC zone or when the write booster area needs to be flushed, the storage device 100 may move the data 1001 stored in the write booster area 117 to the SLC zone based on the added mapping table 1030 and may store data 1013 therein. According to an embodiment, when a first logical address of the write booster area and a second logical address (or second physical address) of the SLC zone are mapped in the mapping table 1030, the storage device 100 may obtain data by reading the physical address of the memory 110, which corresponds to the first logical address of the write booster area 117, and may store the obtained data at the physical address (second physical address) of the memory 110, which corresponds to the second logical address of the SLC zone.

As described above, the embodiments of the present disclosure can resolve the error in which continuous data is not written to the zone area that may occur when both the zone storage technology and the write booster technology are activated.

The foregoing is only an illustrative description of the spirit of the present disclosure. Various substitutions, modification and changes may be made therein without departing from the essential features of the embodiments of the present disclosure by those skilled in the art. Therefore, the embodiments and accompanying drawings of the present disclosure are not intended for limiting the scope of the present disclosure. The scope of the present disclosure should be construed by the appended claims. All substitutions, modification and changes equivalent to the essential features of the embodiments should be construed to be included in the scope of the present disclosure. Furthermore, the embodiments may be combined to form additional embodiments.

What is claimed is:

1. A storage device comprising:
a memory device; and
a controller connected to an external device and configured to control the memory device,
wherein the controller configures the memory device to include a first storage area, a second storage area and a write booster area, the second storage area having a storage type different from that of the first storage area, and
wherein, when a write booster operation mode is activated by the external device, the controller is configured to:
receive, from the external device, a first data write command for the first storage area,
store, in the write booster area, first write data corresponding to the first data write command,
map address information of the write booster area where the first write data has been stored to address information of the first storage area corresponding to the first data write command, and
increase a write address pointer of the first storage area based on an amount of the first write data.

2. The storage device of claim 1, wherein the controller is further configured to move, into the first storage area, the first write data stored in the write booster area, based on the mapping.

3. The storage device of claim 2, wherein the controller is configured to move the first write data into the first storage area, when the write booster area is flushed or the first storage area is changed to have a state where writing is impossible.

4. The storage device of claim 2, wherein, in the state where the write booster operation mode is activated by the external device, the controller is further configured to:
receive, from the external device, a second data write command for the second storage area,
store, in the second storage area, second write data corresponding to the second data write command based on address information of the second storage area corresponding to the second data write command, and
update management information of the write booster area as if the second write data is stored in the write booster area.

5. The storage device of claim 4, wherein, when flushing the write booster area, the controller is further configured not to move the second write data written as if being stored in the write booster area to the second storage area, based on the management information of the write booster area.

6. The storage device of claim 5, wherein the controller is further configured to activate the write booster operation mode or deactivate the write booster operation mode, based on a command received from the external device.

7. The storage device of claim 6, wherein, when the write booster operation mode is not activated, the controller is further configured to:
receive a third data write command from the external device,
store third write data corresponding to the third data write command in the first storage area or the second storage area, based on address information corresponding to the third data write command.

8. The storage device of claim 5, wherein the controller is further configured to determine whether the data write command is the first data write command or the second data write command, based on the address information corresponding to the data write command received from the external device.

9. The storage device of claim 2, wherein the first storage area is composed of a single level cell (SLC), and the second storage area is composed of an X-level cell (XLC).

10. An operating method of a controller, the operating method comprising:
configuring a memory device to include a first storage area, a second storage area and a write booster area, the second storage area having a storage type different from that of the first storage area;
activating a write booster operation mode;
receiving, from an external device, a first data write command for the first storage area;
storing, in the write booster area, first write data corresponding to the first data write command;
mapping address information of the write booster area where the first write data has been stored to address information of the first storage area corresponding to the first data write command; and
increasing a write address pointer of the first storage area based on an amount of the first write data.

11. The operating method of claim 10, further comprising:
moving, into the first storage area, the first write data stored in the write booster area, based on the mapping.

12. The operating method of claim 11, wherein the moving of the first write data is performed, when the write booster area is flushed or the first storage area is changed to have a state where writing is impossible.

13. The operating method of claim 11, further comprising:
receiving, from the external device, a second data write command for the second storage area;
storing, in the second storage area, second write data corresponding to the second data write command based on address information of the second storage area corresponding to the second data write command; and
updating management information of the write booster area as if the second write data is stored in the write booster area.

14. The operating method of claim 13, further comprising:
flushing the write booster area without moving the second write data written as if being stored in the write booster area to the second storage area based on the management information of the write booster area.

15. The operating method of claim 14, wherein the activating the write booster operation mode comprises activating the write booster operation mode or deactivating the write booster operation mode based on a command received from the external device.

16. The operating method of claim 15, further comprising:
when the write booster operation mode is not activated,
receiving a third data write command from the external device, and
storing third write data corresponding to the third data write command in the first storage area or the second storage area, based on address information corresponding to the third data write command.

17. The operating method of claim 10, further comprising:
determining whether the data write command is the first data write command or the second data write command, based on the address information corresponding to the data write command received from the external device.
